(19) United States
(12) Patent Application Publication
(10) Pub. No.: US 2025/0065874 A1
(43) Pub. Date: Feb. 27, 2025

(54) METHOD FOR OPERATING A DRIVING ASSISTANCE SYSTEM FOR A MOTOR VEHICLE, APPARATUS, DRIVING ASSISTANCE SYSTEM, MOTOR VEHICLE, AND COMPUTER PROGRAM

(71) Applicants: HYUNDAI MOTOR COMPANY, Seoul (KR); Kia Corporation, Seoul (KR)

(72) Inventors: Lukas Gaß, Mainz (DE); Dominik MATHEIS, Hanau (DE)

(73) Assignees: HYUNDAI MOTOR COMPANY, Seoul (KR); Kia Corporation, Seoul (KR)

(21) Appl. No.: 18/519,292

(22) Filed: Nov. 27, 2023

(30) Foreign Application Priority Data
Aug. 22, 2023 (DE) 102023122388.7

(51) Int. Cl. B60W 30/18

(52) U.S. Cl. CPC B60W 30/18009; B60W 2420/403; B60W 2520/105; B60W 2552/05; B60W 2555/20; B60W 2555/60; B60W 2556/40; B60W 2556/50; B60W 2556/65

(57) ABSTRACT

A method for operating a driving assistance system for a motor vehicle includes receiving first data configured to indicate an announcement of at least one of a driving situation and a road situation being expected to be of the motor vehicle. Furthermore, the method includes determining at least one parameter of at least one detection device of the driving assistance system based on the first data. Furthermore, the method includes providing the at least one parameter for preconditioning the at least one detection device to the at least one of the driving situation and the road situation. Furthermore, there is provided a corresponding apparatus, a driving assistance system, a motor vehicle, and a computer program.

### CROSS-REFERENCE TO RELATED APPLICATION

The present application claims priority to German Patent Application No. 102023122388.7 filed on Aug. 22, 2023, the entire contents of which is incorporated herein for all purposes by this reference.

### BACKGROUND OF THE PRESENT DISCLOSURE

### Field of the Present Disclosure

The present disclosure relates to a method for operating a driving assistance system for a motor vehicle. Furthermore, the present disclosure relates to an apparatus for a driving assistance system for or of a motor vehicle, a driving assistance system for a motor vehicle, a motor vehicle, and a computer program (product).

### Description of Related Art

Current motor vehicles are increasingly provided with detection devices to implement driving assistance, an advanced driver-assistance system (ADAS), autonomous driving functionalities, or the like. For example, a motor vehicle may be provided with one or more detection devices, such as sensors or the like, and various techniques for obtaining data from the environment, e.g., to provide accurate detection of e.g., a traffic environment of the motor vehicle, traffic participants, of the road ahead and/or behind, etc. Typical technologies that are utilized for the present purpose include radio detection and ranging (RADAR), laser, Light Detection and Ranging (LiDAR), ultrasound, cameras, stereo vision, computer vision, odometry, accelerometers, gyroscopes, GPS, etc.

In some situations, e.g., driving situations and/or road situations, however, one or more parameters of such detection device may not fit to the situation. For example. because the lane width differs from the normal situation, the lane markings are different, the lighting conditions are different, or the like. In such situation, the detection quality may be insufficient to ensure adequate functioning of the driving assistance, the advanced driver-assistance system (ADAS), autonomous driving functionalities, etc.

Hence, there is a need to find solutions for improving the detection or perception quality of a detection device of a driving assistance system for a motor vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method, an apparatus, a driving assistance system, a motor vehicle, and a computer program.

According to one aspect of the present disclosure, there is provided a method for operating a driving assistance system for and/or of a motor vehicle. The method includes receiving first data configured to indicate an announcement of at least one of a driving situation and a road situation being expected to be upcoming for or ahead of the motor vehicle. Furthermore, the method includes determining at least one parameter of at least one detection device of the driving assistance system based on the first data. Furthermore, the method includes providing the at least one parameter for preconditioning the at least one detection device to the at least one of the driving situation and the road situation.

One idea of the present disclosure is to adjust, possibly optimize, one or more parameters of the at least one detection device toward an improved detection quality and/or perception quality even before the motor vehicle reaches a predetermined situation, in the (pre-)announced driving situation and/or road situation. In other words, one or more default parameters designed for a plurality of different situations may already be adjusted in advance, either individually or as a parameter set, to be, e.g., better adapted to a specific situation which is yet to occur. Thus, the driving assistance system may be kept working even in critical situations by adjusting, e.g., optimizing, parameters depending on such situation.

As a consequence, the driving assistance system may be preconditioned so that already before or upon reaching the situation a, e.g., better, optimized, or the like, detection quality and/or perception quality of the corresponding at least one detection device of an environment of the motor vehicle and/or of the motor vehicle's surroundings may be enabled. This may enable the driving assistance system to remain operational and/or provide improved or optimized performance, even in challenging situations. The preconditioning is therefore to be distinguished in terms of time from optimized postprocessing of detection data, as it already optimizes it before and/or during the detection.

As used herein, the driving assistance system may be any technical means configured to assist one or more driving functions. Accordingly, the driving assistance system may be configured to assist a driver, i.e., be (advanced) driver-assistance system (ADAS), or to assist and/or enable an at least partially automated driving function and/or autonomous driving function, e.g., of a self-driving vehicle. by way of example, the driving assistance system may include at least one of an (adaptive) cruise control, collision avoidance system, automatic parking, forward collision warning, an intelligent speed adaptation, an intersection assistance, a lane-changing assistance, a lane departure warning, a traffic sign recognition, an automotive night vision, and an at least semi-autonomous driving function, to name just a few examples. The driving assistance system is not limited herein.

The driving assistance system may be configured to utilize one or more detection devices, e.g., sensors or the like, to detect and/or perceive the motor vehicle's surroundings, such as optical and thermographic cameras, radio detection and ranging (RADAR), LiDAR, ultrasound/sonar, GPS, odometry and inertial measurement units, to name just a few examples. Each of these detection devices may rely on one or more parameters, which may be preset individually or as a set of parameters in accordance with the description provided herein, even before a particular situation occurs.

Accordingly, the at least one parameter determined for preconditioning the at least one detection device before the situation actually occurs, i.e., before the motor vehicle reaches the situation, may be related to the detection quality, detection capability, perception quality, perception capability, or the like of the at least one detection device with respect to that upcoming situation. For example, for a camera, the at least one parameter may be or may relate to color model, field of view, zooming factor, contrast, exposure value (e.g., F, time, ISO, etc.), aperture, resolution, focal length, or the like. Furthermore, by way of example, for radio detection and ranging (RADAR), the at least one parameter may be or may relate to power gain, directivity or directive (gain), polarization, range, field of view, or the like. For LiDAR, the at least one parameter may be or may relate to e.g., range, field of view, scan pattern, insensitivity, detection rate, distance precision and/or measurement accuracy, or the like. It is understood that virtually any detection device which may be used for a driving assistance system may have one or more parameters which may be optimized for a particular situation with respect to detection and/or perception, so that the at least one parameter is not limited herein.

Furthermore, as used herein, the at least one of the driving situation and the road situation may refer to any type of driving condition, road condition, traffic condition, building condition, or in general in particular external influences, which may be imminent, i.e., it has not yet occurred, but is predicted, for the motor vehicle and may influence the corresponding expected-to-be-upcoming situation. The announcement of the at least one of the driving situation and the road situation may refer to one or more corresponding situations, conditions, etc. towards which the motor vehicle is driving, but which has not yet been reached at the time of the announcement and/or at the time of the determination of the at least one parameter, or from which the motor vehicle is still at a distance at that time. It is noted that the phrase “driving situation and/or road situation being at least expected to be upcoming for or ahead of the motor vehicle” used herein may be understood as meaning, for example, that although it may be concluded with a certain degree of probability based on the first data that such driving situation and/or road situation is ahead of a direction of travel of the motor vehicle, it cannot (yet) be confirmed with certainty.

The provided method may be conducted by any determining means and may be a computer-implemented method. For example, the method may be at least partially conducted by an on-board computer of the motor vehicle. This may be, for example, an electronic control unit or the like. However, the method may also be at least partially conducted by a computer located remotely from the motor vehicle, such as a server, computer cloud, or the like. In the instant case, there may be a data link between the remote computer and the motor vehicle, such as a radio link or the like. For data exchange, e.g., for receiving the first data, one or more data interfaces, communication interfaces or the like may be provided. The method may also be conducted by a distributed computer system. The at least one parameter determined may, for example, be stored by the motor vehicle itself or received from the remote computer. For example, it may be stored in a suitable data source and/or may be computed in real time and/or during runtime.

It is understood that the term “vehicle” or “vehicular” or other similar term as used herein is inclusive of motor vehicles in general such as passenger vehicles including sports utility vehicles (SUV), buses, trucks, various commercial vehicles, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles. Also, the vehicle may be an at least semi-automated vehicle, i.e., self-driving and/or (semi-) autonomous vehicle. The motor vehicle may also be referred to as ego vehicle.

According to an exemplary embodiment of the present disclosure, the preconditioning of the at least one detection device may be performed before the motor vehicle reaches the at least one of the announced driving situation and the announced traffic situation. Thus, the at least one detection device may already be adjusted to the corresponding situation to be optimized when the situation is reached.

In an exemplary embodiment of the present disclosure, the preconditioning of the at least one detection device may include proactively adjusting the at least one detection device using the at least one parameter prior to driving situation-related or road situation-related data processing based on the at least one detection device. That is, the at least one parameter may be proactively adjusted before data processing, e.g., image data processing, radio detection and ranging (RADAR) data processing, LiDAR data processing, or the like. In the present way, the detection data to be processed can already be optimized, so that the subsequent data processing may also be of better quality.

According to an exemplary embodiment of the present disclosure, the at least one parameter may be configured to proactively adjust detection or perception quality of the at least one detection device to the at least one of the announced driving situation and the announced traffic situation. As described herein, adjusting the detection quality and/or perception quality may be related to the detection quality, detection capability, perception quality, perception capability, or the like of the at least one detection device, even before the at least one of the announced driving situation and the announced traffic situation actually occurs.

In an exemplary embodiment of the present disclosure, the at least one parameter may be configured to overrule a corresponding at least one default parameter of the at least one detection device. The at least one default parameter may be configured to fit a plurality of situations, but therefore represents a compromise, but not an optimum, for at least some of the conceivable situations. However, once the at least one situation-specific parameter has been determined, it may at least temporarily replace the at least one default parameter. This means that instead of the at least one default parameter, the parameter specific to the upcoming situation is used.

According to an exemplary embodiment of the present disclosure, prior to the determining of the at least one parameter, the method may further include identifying the at least one of the driving situation and the road situation based on the first data. This may be conducted by data processing of the first data. This data processing may be conducted by on-board resources of the motor vehicle itself, by e.g., the remote computer mentioned above, or in a distributed manner.

In an exemplary embodiment of the present disclosure, the first data may be obtained based on at least one of the following: object recognition, object identification, traffic sign recognition, road map data, vehicle-to-everything (V2X) information, vehicle-to-vehicle (V2V) information, a traffic information service, a weather information service, satellite navigation position data, detection device data from the motor vehicle, and a database. For example, the motor vehicle may pass a traffic sign indicating “road works ahead” or the like, so that, based on e.g., traffic sign recognition, object recognition, or the like, it may be determined that there is road works and/or a road construction site ahead. Likewise, such road construction site may be determined from a traffic information service, map data, or the like. Furthermore, by way of example, an upcoming road tunnel may be detected by use of map data, an ambient light sensor of the motor vehicle and/or another vehicle by use of vehicle to Vehicle (V2V) communication, by detecting a corresponding traffic sign, i.e., by traffic sign recognition, or the like. Furthermore, by way of example, an upcoming weather condition or event may be determined based on V2V and/or V2X information, a rain sensor of the motor vehicle and/or another vehicle by use of V2V communication, a temperature sensor of the motor vehicle and/or another vehicle by using V2V communication, a weather forecast, or the like. Furthermore, by way of example, an upcoming parking garage may be detected based on V2X information, a traffic sign, i.e. by traffic sign recognition, Global Navigation Satellite Systems (GNSS) information, e.g., a corresponding signal loss, or the like. For example, upcoming speed bumps, may be detected based on map data, e.g., indicating a speed limited zone, a school neighborhood, traffic sign recognition, or the like. Furthermore, by way of example, a border crossing may be detected based on Global Positioning System (GPS) position, or the like.

According to an exemplary embodiment of the present disclosure, wherein, prior to the determining of the at least one parameter, the method may further include receiving second data, wherein the second data may be obtained by use of at least one on-board resource of the motor vehicle itself. The second data may be configured to at least indicate confirmation of the at least one of the announced driving situation and the announced road situation. In other words, the method may await confirmation of the upcoming situation and may then determine the at least one parameter. For example, one or more detection device of the motor vehicle, i.e., the ego vehicle, may be utilized to confirm the situation first. by way of example, this may include a camera-based detection of a road tunnel, a road construction site, or the like. Furthermore, by way of example, a rain sensor may be indicative for upcoming rain. Furthermore, for example, a lowered speed may also be indicative for the upcoming situation.

In an exemplary embodiment of the present disclosure, the second data may be obtained based on at least one of the following: image recognition data, object recognition data, a sensor operating state data, rain sensor data, ambient light sensor data, changed motor vehicle driving data, a lowered motor vehicle speed when approaching the announced driving situation and/or the announced road situation, and current satellite navigation position data of the motor vehicle.

According to an exemplary embodiment of the present disclosure, the method may further include updating at least one of the first data and/or a data source underlying the first data and/or the at least one of the driving situation and the road situation. The second data may be obtained by use of at least one on-board resource of the motor vehicle itself. For example, the data source, e.g., a database or the like, may be, e.g., continuously, updated with information obtained from the motor vehicle, i.e., the ego vehicle. Furthermore, the information related to the situation may be shared with other vehicles. Also, the at least one parameter determined for the situation may be shared with other vehicles. Furthermore, obtaining the second data may include providing a driver of the vehicle with a prompt to confirm the at least one of the driving situation and the road situation before generating the second data.

In an exemplary embodiment of the present disclosure, the method may further comprise, before the motor vehicle leaves the at least one of the driving situation and the road situation again or upon leaving the at least one of the driving situation and the road situation, causing the provided at least one parameter to be replaced by a corresponding at least one default parameter. For example, as soon as the situation comes to its end, the at least one default parameter may be applied to the at least one detection device. This replaces the at least one parameter adjusted to the situation again by a more generally valid (normal) parameter or parameter set.

According to an exemplary embodiment of the present disclosure, the at least one of the driving situation and the road situation may be selected from: a road construction site, a road tunnel, a weather condition or weather event, a parking garage, a road crossing and/or intersection, a railroad crossing, a speed bump, a changing road condition. It is noted that these situations are mere examples and are not limited herein. Accordingly, the present disclosure may be applied to any situation in which a tailored parameter may enhance the detection or perception quality of the at least one detection device.

It is understood that for different situations, different requirements are imposed on the driving assistance system of the motor vehicle with respect to detection and/or perception. For example, the road construction site may have lane markings, which may be only temporarily and may differ from normal, such as yellow color instead of white color. Furthermore, they may be additional road barrier types, more narrow lanes, a dirty road surface, or the like. Also, in context of the road tunnel, there may be no GPS signal available, the presence of artificial light, illuminated road signs, curbs and/or alternative lane markings, a drifting signal of wheel rotation speed, etc. The weather event may cause, for example, a wet road, which may cause reflections on the road, covered lane markings, a visible path of a vehicle ahead, water spray, fog, or the like. When entering the parking garage, there may be no GPS signal available, no map data available, artificial light, speed bumps, low speed driving, a requirement of precise positioning due to the narrow construction, a risk of pedestrians or surprisingly moving vehicles, etc. Furthermore, many other situations are conceivable, such as border crossing, which may change the traffic signs in terms of size, shape, position, color, etc., the color and style of road or lane markings, the width of the roadway, etc. Also, entering built-up areas, such as a city or the like, may also cause different conditions, for example, compared to driving on a highway or cross-country, etc.

Exemplary adjustments of the at least one parameter may include the following. It is noted that these exemplary adjustments are merely for better illustration and not intended to limit the at least one parameter. Accordingly, by way of example, for the road construction site, there may be determined changed contrast parameters for a camera, e.g., to search yellow lanes instead of white, a changed colour model (YUV), e.g., to better identify colours, a changing detection algorithm, e.g., to look for other lane barrier types, a field of view lifted higher to detect road barriers, or the like. For the road tunnel, there may be determined a field of view lifted to detect e.g., signs on upper portion of tunnel, a higher Exposure Value (EV), to provide e.g., more brightness, to detect edge portions of walls and curbs, which may be in a shadow. It is noted that, in some countries, a tunnel may be provided with lightened lane marking, so that the EV may be lowered to increase precision of detection light sources. For the weather event, there may be determined a lowered threshold for lane marking contrast, a change of field of view, e.g., lowered closer to vehicle in case of bright light, an adjusted field of view to detect track of the leading vehicles in standing water on the road, a changed colour model (HSV or HSL) to handle reflections & direct sunlight. For the parking garage, there may be determined a changed colour model (YUV) to better identify colours e.g., to detect different colours of parking spaces vs. driving spaces, an adjusted field of view to detect ground markings in the middle portion of the lane like arrows, retro-reflective markers, or the like. For the speed bumps, short interruptions may be ignored to keep system working, a steering angle may be used to verify driving straight, or the like. For the border crossing, contrast parameters of a camera may be adjusted, a field of view to changed lane width and lane marking width may be adjusted, a field of view in case of different road signs heights may adjusted, wherein the particular adjustments may depend on the respective country. It is noted that for each situation also only one parameter may be set at a time, and other parameters may be added to the above list.

It is noted that the above method may be applied to any detection device of the motor vehicle. Accordingly, there may be determined and provided multiple parameters, also for multiple detection devices.

According to another aspect of the present disclosure, there is provided an apparatus for a driving assistance system for a motor vehicle. The apparatus includes a data processor. The data processor is configured to receive first data configured to indicate an announcement of at least one of a driving situation and a road situation being expected to be upcoming for and/or ahead of the motor vehicle. Furthermore, the data processor is configured to determine at least one parameter of at least one detection device of the driving assistance system based on the first data. Furthermore, the data processor is configured to provide the at least one parameter for preconditioning the at least one detection device to the at least one of the driving situation and the road situation.

The apparatus may be applied to the driving assistance system and/or the motor vehicle described herein. For example, the apparatus may form a portion of the driving assistance system and/or the motor vehicle. The apparatus may be implemented by at least one electronic control module of the motor vehicle. Furthermore, the apparatus may be implemented in a distributed manner, e.g., partially in the motor vehicle and partially in a remote computer.

The apparatus may be configured to carry out the method described herein. Regarding possible embodiments of the apparatus, reference is made to the method described herein.

According to another aspect of the present disclosure, a driving assistance system for a motor vehicle is provided. The driving assistance system includes a data processor. Furthermore, the driving assistance system includes at least one detection device configured to detect and/or perceive an environment and/or surroundings of the motor vehicle. The data processor is configured to receive first data configured to indicate an announcement of at least one of a driving situation and a road situation being expected to be upcoming for and/or ahead of the motor vehicle. Furthermore, the data processor is configured to determine at least one parameter of at least one detection device of the driving assistance system based on the first data. Furthermore, the data processor is configured to provide the at least one parameter for preconditioning the at least one detection device to the at least one of the driving situation and the road situation.

The driving assistance system may be applied to the motor vehicle. The driving assistance system may be configured to carry out the method described herein. Regarding possible embodiments of the apparatus, reference is made to the method described herein.

According to another aspect of the present disclosure, there is provided a motor vehicle. The motor vehicle includes an apparatus according to the aspect described above. Additionally or alternatively, the motor vehicle includes a driving assistance system according to the aspect described above.

According to another aspect of the present disclosure, there is provided a computer program. The computer program includes instructions which, when the program is executed by a computer, cause the computer to carry out the method of the aspect described above.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 schematically depicts a motor vehicle including a driving assistance system and/or an apparatus according to an exemplary embodiment of the present disclosure, wherein FIG. 1 further depicts schematically an exemplary application scenario of the present disclosure.

FIG. 2 schematically depicts an apparatus for a driving assistance system and/or for a motor vehicle according to an exemplary embodiment of the present disclosure.

FIG. 3 schematically depicts in a flow chart an automatic parameter adjustment (scheme) according to an exemplary embodiment of the present disclosure.

FIG. 4 shows a flow diagram of a method for operating a driving assistance system for a motor vehicle according to an exemplary embodiment of the present disclosure.

Although predetermined embodiments are illustrated and described herein, it will be appreciated by those of ordinary skill in the art that a variety of alternate and/or equivalent implementations may be substituted for the predetermined embodiments shown and described without departing from the scope of the present disclosure. Generally, the present application is directed to cover any adaptations or variations of the predetermined embodiments discussed herein.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

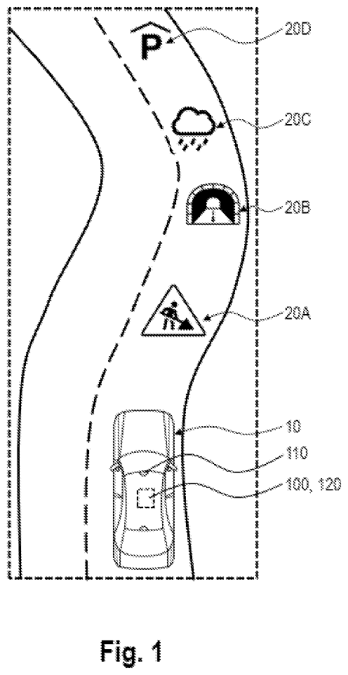

FIG. 1 schematically depicts an exemplary motor vehicle 10 including a driving assistance system 100. The motor vehicle 10 and/or the driving assistance system 100 includes at least one detection device 110. Furthermore, the motor vehicle 10 and/or the driving assistance system 100 includes an apparatus 120. The apparatus 120 may be operationally coupled to the driving assistance system 100 and/or the at least one detection device 110, may form a part of the driving assistance system 100, or may be otherwise applied to the motor vehicle 10. The driving assistance system 100 is configured to, for example, assist a driver of the vehicle 10, e.g., may form an advanced driver-assistance system (ADAS), perform a (semi-)automatic driving function, or the like.

The at least one detection device 110, e.g., a sensor or the like, is configured to detect and/or perceive the motor vehicle 10's surroundings, environment, etc. For example, the at least one detection device 110 may include an optical camera, a thermographic camera, radio detection and ranging (RADAR), LiDAR, ultrasound/sonar, GPS, odometry and inertial measurement units, or the like.

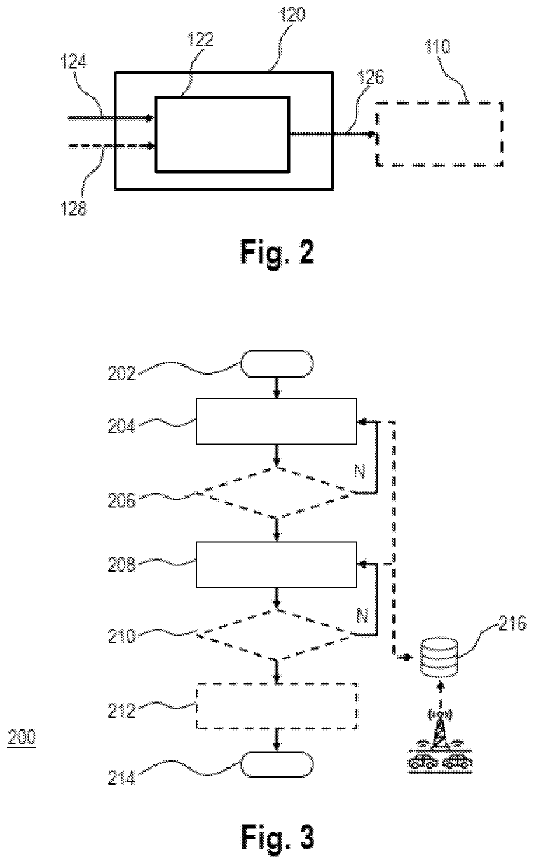

FIG. 2 schematically depicts an example of the apparatus 120. The apparatus 120 includes a data processor 122. It is noted that the data processor 122 may also be formed as a Field Programmable Gate Array (FPGA), or the like. The data processor 122 is configured to receive first data 124 configured to indicate an announcement of a driving situation and/or road situation being at least expected to be upcoming for and/or ahead of the motor vehicle 10. Furthermore, the data processor 122 is configured to determine at least one parameter 126 of the at least one detection device 110 of the driving assistance system 100 based on the first data 124. Furthermore, the data processor 122 is configured to provide the at least one parameter 124 for preconditioning the at least one detection device 110 to the at least one of the driving situation and the road situation.

In other words, before the motor vehicle 10 reaches the announced driving situation and/or the announced road situation, the apparatus 120 may be configured to determine the at least one parameter 126 of the at least one detection device 110 to optimize a detection quality, perception quality, or the like of the at least one detection device 110 for the respectively upcoming situation, even before the motor vehicle 10 has actually reached that situation.

For example, the first data 124 may be obtained based on and/or received from at least one of the following: object recognition, traffic sign recognition, road map data, vehicle-to-everything (V2X) information, vehicle-to-vehicle (V2V) information, a traffic information service, a weather information service, satellite navigation position data, and a database. Accordingly, the first data 124 may be obtained by the motor vehicle 10 itself and/or from a remote data source.

Furthermore, by way of example, the at least one parameter 126 may be obtained, e.g., loaded, received, or the like, from any suitable data source. For example, the data source may be implemented on-board, i.e., in the motor vehicle 10 itself, or may be received from a remote data source, such as a data base, another vehicle, or the like, using a communication interface, V2V, V2X, or the like.

Furthermore, the at least one detection device 110 may rely on the one or more parameters 126, which may be preset individually or as a set of parameters, even before the announced situation occurs. Accordingly, the at least one parameter 126 may be related to the detection quality, detection capability, perception quality, perception capability, or the like of the at least one detection device with respect to that upcoming situation. For example, for a camera, the at least one parameter 126 may be or may relate to color model, field of view, zooming factor, contrast, exposure value (e.g., F-stop, time, ISO film speed, etc.), aperture, resolution, focal length, or the like. Furthermore, by way of example, for radar, the at least one parameter may be or may relate to power gain, directivity or directive (gain), polarization, range, field of view, or the like. For LiDAR, the at least one parameter may be or may relate to e.g., range, field of view, scan pattern, insensitivity, detection rate, distance precision and/or measurement accuracy, or the like. It is understood that virtually any detection device which may be used for a driving assistance system may have one or more parameters which may be optimized for a particular situation with respect to detection and/or perception, so that the at least one parameter is not limited herein.

Furthermore, optionally, the apparatus 120, e.g., the data processor 122, may be configured to receive second data 128 obtained by use of at least one on-board resource of the motor vehicle itself and configured to at least indicate confirmation of the at least one of the announced driving situation and the announced road situation. The at least on-board resource may be the at least one detection device 110 or any other detection device, sensor, or the like, which is configured to confirm the announced driving situation and/or the announced road situation from the motor vehicle 10, i.e., the ego vehicle.

Referring again to FIG. 1, an exemplary application scenario for the motor vehicle 10, the driving assistance system 100 and/or the apparatus 120 will be further explained below.

Accordingly, FIG. 1 depicts an exemplary road course and/or road or traffic scene where the motor vehicle 10 may be operated. The road course may be cross-country, on a highway, through a city, etc.

During operation of the motor vehicle 10 in such application scenario, a wide variety of situations, i.e., the above-mentioned driving situation and/or road situation, may occur with which the motor vehicle 10's driving assistance system 100 may be encountered. In FIG. 1, these exemplary situations are denoted by reference sign(s) 20x. Only by way of example, FIG. 1 shows a road construction site 20A, a road tunnel 20B, some weather event 20C, and a parking garage 20D, which should not be understood herein as limiting the kind of situation 20x, but rather for better illustration of the driving assistance system 100 and/or the apparatus 120.

It is understood that for different situations 20x, different requirements are imposed on the driving assistance system 100 of the motor vehicle 10 with respect to detection and/or perception. For example, the road construction site 20A may have lane markings, which may be only temporarily and may differ from normal, such as yellow color instead of white color. Furthermore, they may be additional road barrier types, more narrow lanes, a dirty road surface, or the like. Also, in context of the road tunnel 20B, there may be no GPS signal available, the presence of artificial light, illuminated road signs, curbs and/or alternative lane markings, a drifting signal of wheel rotation speed, etc. The weather event 20C may cause, for example, a wet road, which may cause reflections on the road, covered lane markings, a visible path of a vehicle ahead, water spray, fog, or the like. When entering the parking garage 20D, there may be no GPS signal available, no map data available, artificial light, speed bumps, low speed driving, a requirement of precise positioning due to the narrow construction, a risk of pedestrians or surprisingly moving vehicles, etc. Furthermore, many other situations are conceivable, such as border crossing, which may change the traffic signs in terms of size, shape, position, color, etc., the color and style of road or lane markings, the width of the roadway, etc. Also, entering built-up areas, such as a city or the like, may also cause different conditions, for example, compared to driving on a highway or cross-country, etc.

It should be noted that all the exemplary situations 20x have in common that they are initially ahead of the motor vehicle 10 with respect to a direction of travel thereof. The above-mentioned announced driving situation and/or road situation may be any one of the above situations 20x, i.e., the road construction site 20A, a road tunnel 20B, some weather event 20C, a parking garage 20D, or the like, as exemplarily depicted in FIG. 1. As mentioned above, each one of these situations 20x may be regarded as upcoming for and/or being ahead of the motor vehicle 10, since the motor vehicle 10, as indicated in FIG. 1, may be driving toward it, but has not yet reached it.

Furthermore, it is understood that the above-mentioned at least one parameter 126 of the at least one detection device 110 may not be designed for all the different situations 20x and may not provide the same detection quality and/or perception quality in each situation. However, by the above driving assistance system 100 and/or the above apparatus 120, the at least one parameter 126 may be provided in a tailored and/or situation-optimized manner even before the motor vehicle 10 reaches the corresponding situation 20x.

FIG. 3 schematically depicts in a flow chart an automatic adjustment 200 of the above at least one parameter 112 of the at least one detection device 110 for the exemplary situations 20x shown in FIG. 1. It is noted that the above apparatus 120 and/or the above driving assistance system 100 may be operated in accordance with that flow chart. The automatic adjustment 200 may, for example, implemented as a computer program or the like.

The automatic adjustment 200 starts with block 202. At the present point, the motor vehicle 10 may approach one of the exemplary situations 20x shown in FIG. 1 but have not reached it. At block 204, the respective situation 20x may be announced by the first data 124. Block 206 may be optional. At block 206, the respective situation 20x may be confirmed by the above-mentioned second data 128, i.e., by the motor vehicle 10 itself, i.e., the ego vehicle. At block 206, if the situation is not confirmed by the second data 128 (result=N), it may be returned to block 204. At block 208, the at least one parameter 126 is determined and/or provided to the at least one detection device 110. It is noted that this is done before and/or when the situation 20x is reached. Blocks 210 and 212 are optional. At block 210, optionally, it is determined whether the situation 20x is going to end. Because, for example, before the motor vehicle 10 leaves the at least one of the driving situation and the road situation, i.e., one of the situations 20x, again or upon leaving the at least one of the driving situation and the road situation, the apparatus 120 may cause the provided at least one parameter to be replaced by a corresponding at least one default parameter. At block 210, if the situation does not end yet (result=N) the at least one parameter 126 is still maintained and/or continuously adjusted to the situation 20x. At block 212, the at least one default parameter is applied to the at least one detection device 110. At block 214, the automatic adjustment 200 ends.

It is noted that, optionally, a data source 216, configured to store and/or provide the at least one parameter 126 and/or a matching of the at least one parameter 126 and the respective situation 20x, may be updated. For example, the data source 216 may be updated based on the information obtained at block 202, i.e., based on the second data 128, or the like. Furthermore, the information related to the respective situation 20x, and/or its detection and/or the best at least one parameter 126 may be shared across a vehicle fleet, e.g., via V2V and/or V2X, or the like.

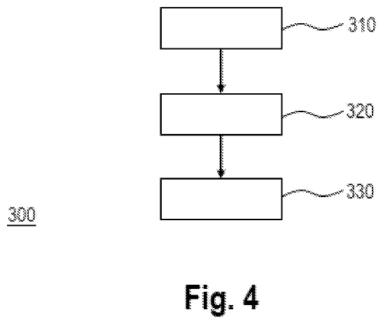

FIG. 4 depicts in flow chart an exemplary method 300 for operating a driving assistance system and/or a motor vehicle. The method 300 may be conducted by the motor vehicle 10, the driving assistance system 100 and/or the apparatus 120.

The method 300 includes a step 310 of receiving first data 124 configured to indicate an announcement of a driving situation and/or road situation 20x being at least expected to be upcoming for and/or ahead of the motor vehicle 10. Furthermore, the method 300 includes a step 320 of determining at least one parameter 126 of at least one detection device 110 of the driving assistance system 100 based on the first data (124). Furthermore, the method includes a step 330 of providing the at least one parameter 126 for preconditioning the at least one detection device 110 to the at least one of the driving situation and the road situation 20x.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for operating a driving assistance system for a motor vehicle, the method comprising:
receiving, by a processor, first data configured to indicate an announcement of at least one of a driving situation and a road situation being expected to be upcoming for or ahead of the motor vehicle;
determining, by the processor, at least one parameter of at least one detection device of the driving assistance system based on the first data; and
providing, by the processor, the at least one parameter for preconditioning the at least one detection device to the at least one of the driving situation and the road situation.

2. The method of claim 1, wherein the preconditioning of the at least one detection device is performed by the processor before the motor vehicle reaches the at least one of the announced driving situation and the announced traffic situation.

3. The method of claim 1, wherein the preconditioning of the at least one detection device includes proactively adjusting, by the processor, the at least one detection device using the at least one parameter prior to driving situation-related or road situation-related data processing based on the at least one detection device.

4. The method of claim 1, wherein the at least one parameter is configured to proactively adjust detection or perception quality of the at least one detection device to the at least one of the announced driving situation and the announced traffic situation.

5. The method of claim 1, wherein the at least one parameter is configured to overrule a corresponding at least one default parameter of the at least one detection device.

6. The method of claim 1, wherein the first data is obtained based on at least one of object recognition, traffic sign recognition, road map data, vehicle-to-everything, Vehicle-To-Everything (V2X), information, vehicle-to-vehicle, Vehicle-To-Vehicle (V2V), information, a traffic information service, a weather information service, satellite navigation position data, detection device data from the motor vehicle, and a database.

7. The method of claim 1, wherein, prior to the determining of the at least one parameter, the method further includes:
receiving, by the processor, second data obtained by use of at least one on-board resource of the motor vehicle itself and configured to indicate confirmation of the at least one of the announced driving situation and the announced road situation.

8. The method of claim 7, wherein the second data is obtained based on at least one of image recognition data, object recognition data, a sensor operating state data, rain sensor data, ambient light sensor data, changed motor vehicle driving data, a lowered motor vehicle speed in approaching the at least one of the announced driving situation and the announced road situation, and current satellite navigation position data of the motor vehicle.

9. The method of claim 1, further including:
updating, by the processor, at least one of the first data or a data source underlying the first data or the at least one parameter based on second data obtained by use of at least one on-board resource of the motor vehicle itself.

10. The method of claim 1, further including:
before the motor vehicle leaves the at least one of the driving situation and the road situation again or upon leaving the at least one of the driving situation and the road situation, causing, by the processor, the provided at least one parameter to be replaced by a corresponding at least one default parameter.

11. The method of claim 1, wherein the at least one of the driving situation and the road situation is selected from a road construction site, a road tunnel, a weather condition, a parking garage, an intersection, a railroad crossing, a speed bump, a changing road condition, and a border crossing.

12. An apparatus for a driving assistance system for a motor vehicle, the apparatus comprising a data processor configured to:
receive first data configured to indicate an announcement of at least one of a driving situation and a road situation being expected to be upcoming for or ahead of the motor vehicle;
determine at least one parameter of at least one detection device of the driving assistance system based on the first data; and
provide the at least one parameter for preconditioning the at least one detection device to the at least one of the driving situation and the road situation.

13. The apparatus of claim 12, wherein in the preconditioning of the at least one detection device, the processor is configured for proactively adjusting the at least one detection device using the at least one parameter prior to driving situation-related or road situation-related data processing based on the at least one detection device.

14. The apparatus of claim 12, wherein, prior to the determining of the at least one parameter, the processor is further configured for receiving second data obtained by use of at least one on-board resource of the motor vehicle itself and configured to indicate confirmation of the at least one of the announced driving situation and the announced road situation.

15. A driving assistance system for a motor vehicle, the system comprising:
at least one detection device configured to detect or perceive surroundings of the motor vehicle, and
a data processor,
wherein the processor is configured to:
receive first data configured to indicate an announcement of at least one of a driving situation and a road situation being expected to be upcoming for or ahead of the motor vehicle,
determine at least one parameter of at least one detection device of the driving assistance system based on the first data, and
provide the at least one parameter for preconditioning the at least one detection device to the at least one of the driving situation and the road situation.

16. The driving assistance system of claim 15, wherein in the preconditioning of the at least one detection device, the processor is further configured for proactively adjusting the at least one detection device using the at least one parameter prior to driving situation-related or road situation-related data processing based on the at least one detection device.

17. The driving assistance system of claim 15, wherein, prior to the determining of the at least one parameter, the processor is further configured for receiving second data obtained by use of at least one on-board resource of the motor vehicle itself and configured to indicate confirmation of the at least one of the announced driving situation and the announced road situation.

18. A motor vehicle, including the apparatus of claim 12.

19. A motor vehicle, including the driving assistance system of claim 15.

20. A non-transitory computer-readable recording medium in which a program including instructions which, when the program is executed by the processor, cause the processor to carry out the method of claim 1.
